(19) United States
(12) Patent Application Publication
(10) Pub. No.: US 2026/0200194 A1
(43) Pub. Date: Jul. 16, 2026

(54) Pressing tool, associated operating method, and pressing device

(71) Applicant: Provisur Technologies, Inc., Mokena, IL (US)

(72) Inventors: Manuel SEELHOFER, Degersheim (CH); Lukas BOSSART, Gossau (CH)

(73) Assignee: Provisur Technologies, Inc., Mokena, IL (US)

(21) Appl. No.: 19/443,552

(22) Filed: Jan. 8, 2026

(30) Foreign Application Priority Data
Jan. 14, 2025 (DE) 10 2025 101 168.0

(51) Int. Cl. B30B 15/00; A47J 43/20

(52) U.S. Cl. CPC B30B 15/0094; A47J 43/20

(57) ABSTRACT

A pressing tool is provided for a pressing device for pressing pressed material. e.g. food products. The pressing tool has a transponder chamber and a transponder arranged therein. The transponder chamber is not completely filled when the transponder is mounted, but has an overpressure absorption chamber to absorb the overpressure generated when the transponder is pressed into the transponder chamber. An associated operating method and a correspondingly adapted pressing device are also provided.

### TECHNICAL FIELD OF THE DISCLOSURE

The disclosure relates to a pressing tool for a pressing device for pressing pressed material (e.g. food products). Furthermore, the disclosure relates to an operating method for a pressing device with such a pressing tool. Finally, the disclosure also comprises a correspondingly adapted pressing device.

### BACKGROUND OF THE DISCLOSURE

Pressing devices for pressing food products are known from the prior art (e.g. EP 4 301 562 A2). This is particularly advantageous if the food products are to be sliced afterwards, as the pressing process produces a defined product contour even for food products (e.g. raw ham) with an irregular outer product contour.

It is also known from the prior art to integrate an RFID transponder (RFID: radio frequency identification) into a pressing tool of such a pressing device for pressing food products so that the pressing device can recognize the mounted pressing tool.

In known pressing tools with an integrated RFID transponder, the transponder is usually pressed into a transponder chamber in the pressing tool. However, during operation of such pressing tools, it has happened that the pressed-in RFID transponder has come loose from the transponder chamber again during operation, which must be prevented. A disadvantage of the prior art is therefore the risk that the RFID transponder pressed into the transponder chamber of the pressing tool may come loose again unintentionally.

### DESCRIPTION OF THE DISCLOSURE

The disclosure is therefore based on the task of creating an appropriately improved pressing tool with a transponder.

The pressing tool according to the disclosure is designed to press material (e.g. food products) in a pressing device, as is known from the prior art. However, the disclosure is not limited to food products with regard to the material to be pressed, but can also be used for pressing other materials.

In accordance with the prior art described at the outset, the pressing tool according to the disclosure also has a transponder chamber to accommodate the transponder.

The disclosure is based on the technical-physical finding that the unwanted loosening of the transponder from the transponder chamber occurring in the prior art is due to the fact that when the transponder is pressed into the transponder chamber, excess pressure is generated which acts on the transponder when it is mounted and, in the worst case, can push it out of the transponder chamber again.

In the pressing tool according to the disclosure, the transponder chamber is therefore not completely filled when the transponder is mounted, but has an overpressure absorption chamber to absorb the overpressure generated when the transponder is pushed into the transponder chamber. The overpressure chamber thus prevents the overpressure generated when pressing the transponder into the transponder chamber from rising to such an extent that it could lead to the transponder being unintentionally pushed out of the transponder chamber.

In a preferred embodiment of the disclosure, the overpressure absorption chamber is located at the bottom of the transponder chamber. For example, the overpressure absorption chamber may surround the transponder chamber at the bottom of the transponder chamber in the form of a ring groove. However, the disclosure is not limited to a ring groove in terms of the shape and design of the overpressure chamber.

In the preferred embodiment of the disclosure, the transponder is arranged in a pot-shaped protective cap, which is inserted into the transponder chamber together with the transponder as a package and covers the transponder with its bottom facing outwards. The protective cap can be flush with the surface of the pressing tool with its bottom. Preferably, the protective cap is made of plastic so that the protective cap does not shield the transponder electromagnetically, which would interfere with the wireless reading of the transponder.

Preferably, the protective cap has at least one form-fitting element on its outer circumferential edge, which, when assembled, forms a form-fitting connection with a corresponding complementary form-fitting element in the transponder chamber, thereby anchoring the protective cap form-fittingly in the transponder chamber.

For example, the form-fitting element on the protective cap may be a barb that is anchored in the overpressure absorption chamber when assembled. In the preferred embodiment of the disclosure, several barbs are arranged in the outer surface of the protective cap, which are offset in the press-in direction.

The complementary positive locking element in the transponder chamber mentioned above may, for example, be the overpressure absorption chamber (e.g. ring groove). The barb on the outer wall of the protective cap can thus engage in the overpressure absorption chamber to anchor the protective cap together with the transponder in a positive manner in the transponder chamber.

In the preferred embodiment of the disclosure, the transponder inserted into the protective cap is covered on the inside by a plug that is pressed into the pot-shaped protective cap.

In this case, the transponder in the protective cap can be embedded in a medium, in particular an elastic medium (e.g. silicone). This medium can completely fill the space between the protective cap on the one hand and the plug on the other, so that the transponder is completely embedded in the medium. This embedding of the transponder in the elastic material (e.g. silicone) enables mechanical decoupling of the transponder from external influences such as thermal expansion, deformation, etc.

In addition, a stop may be provided which, when the plug is pressed into the protective cap, limits the pressing movement of the plug and thus provides a defined receiving space for the transponder in the protective cap. For example, the stop may be arranged on the inner wall of the protective cap, on the outer wall of the plug, or on a pressing aid. In the preferred embodiment of the disclosure, this stop is realized as a step in the inner wall of the protective cap.

In the preferred embodiment of the disclosure, the protective cap, the transponder, and the plug thus form a package that is pressed and/or glued together into the transponder chamber in the pressing tool.

The protective cap can therefore be fixed in the transponder chamber by friction, form-fitting, or material bonding. The form-fitting connection is formed, for example, by the barb. The friction connection, on the other hand, is formed by the friction between the outer wall of the protective cap and the inner wall of the transponder chamber. The material bonding connection, on the other hand, is formed by the adhesive connection between the protective cap and the inner wall of the transponder chamber. The protective cap can therefore be anchored simultaneously by three different types of connection (friction-locking, form-locking, and material-bonding).

In one variant of the disclosure, the transponder chamber in the pressing tool is essentially cylindrical, whereby the overpressure absorption chamber can then form an annular groove.

In another variant of the disclosure, the transponder chamber in the pressing tool widens towards its base, in particular conically. The insertion of the package including the protective cap, the plug, and the transponder is preferably made possible by heating the pressing tool and/or cooling the protective cap, which thermally causes a corresponding expansion of the transponder chamber or a corresponding shrinkage of the package including the protective cap, the plug, and the transponder, thereby enabling the package to be inserted into the transponder chamber. The transponder chamber on the one hand and the protective cap on the other are therefore preferably dimensioned in such a way that the protective cap can only be inserted into the transponder chamber or pulled out of the transponder chamber when the protective cap has cooled down or the pressing tool has been heated.

Furthermore, it should be noted that the volume of the overpressure chamber should be sufficiently large so that the overpressure generated when pressing in the transponder does not become so great that it subsequently pushes the transponder out of the transponder chamber again. The volume of the overpressure chamber should therefore be at least 3% or at least 5% of the total volume of the other transponder chamber.

Furthermore, it should be noted that the transponder is preferably an RFID transponder that can be read wirelessly.

In addition, it should be mentioned that the transponder preferably contains a data memory in which tool parameters of the pressing tool can be stored, such as dimensions of the pressing tool, manufacturing tolerances of the dimensions of the pressing tool, or thermal expansion coefficients of the material of the pressing tool. The data storage device can be, for example, a read-only memory or a read-write memory that can be both read and written to.

Furthermore, it should be noted that the transponder can be either a passive transponder without its own power supply or an active transponder with its own power supply.

Furthermore, it should be noted that the pressing tool according to the disclosure may be made of plastic or steel.

In addition to the pressing tool according to the disclosure described above, the disclosure also comprises an operating method for a pressing device with such a pressing tool. Here, at least one tool parameter of the pressing tool is read out from the transponder in the pressing tool and the pressing parameters are then adjusted during pressing depending on the tool parameter read out. The disclosure thus enables the use of different pressing tools with tool-specific adjustment of the pressing parameters.

The tool-dependent adjusted pressing parameters can, for example, be the end position of at least one travel axis during pressing. In addition, the pressing profile, i.e. the pressing force-time characteristic curve or the pressing stroke-time characteristic curve, can also be adjusted as a pressing parameter. The press force-time characteristic curve reflects the course of the press force as a function of time. The press stroke-time characteristic curve, on the other hand, reflects the course of the press stroke as a function of time.

The tool parameters of the pressing tool read out from the transponder can be, for example, one of the following tool parameters:
Dimensions of the pressing tool,
manufacturing tolerances of the dimensions of the pressing tool,
thermal expansion coefficients of the pressing tool.

Furthermore, the disclosure provides the possibility of checking for a rough misalignment of the transponder in the pressing tool as soon as the transponder data is read out.

Finally, the disclosure also comprises a pressing device with the pressing tool according to the disclosure. In addition, the pressing device according to the disclosure also comprises a reader for reading out the transponder and a control device for controlling a pressing process according to specific pressing parameters. The data read out from the transponder comprises at least one tool parameter of the pressing tool, and the control device adjusts the pressing parameters (e.g. pressing force-time characteristic curve) depending on the tool parameters read out from the transponder by the reader.

### BRIEF DESCRIPTION OF THE DRAWINGS

FIG. 1 is a cross-sectional view through a pressing tool according to the disclosure with an embedded transponder.

FIG. 2 is a cross-sectional view through the empty transponder chamber for accommodating the transponder.

FIG. 3 is a cross-sectional view corresponding to FIG. 1 for a modified embodiment with a conically tapering transponder chamber.

FIG. 4 is a flow chart illustrating the operating method according to the disclosure.

FIG. 5 is a schematic representation of a pressing device according to the disclosure.

### DETAILED DESCRIPTION

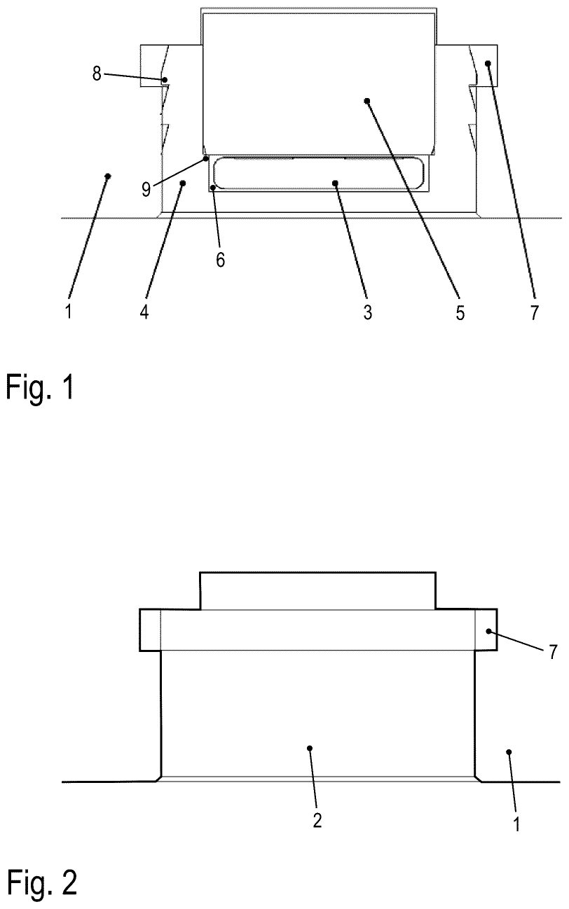

The following section first describes a first embodiment of a pressing tool 1 according to the disclosure, as shown in FIGS. 1 and 2.

It should be noted in advance that the pressing tool 1 is intended for use in a pressing device for pressing food products, as is known from the prior art. The pressing tool 1 is therefore only shown schematically here.

The pressing tool 1 contains a transponder chamber 2 for accommodating a transponder 3, whereby the transponder chamber 2 is shown empty in FIG. 2, whereas FIG. 1 shows the transponder chamber 2 with the transponder 3 arranged therein.

The transponder 3 is arranged in a package including a protective cap 4 and a plug 5, with the space between the plug 5 and the protective cap 4 filled with silicone 6. The transponder 3 is thus completely embedded in the silicone 6 between the plug 5 and the protective cap 4. This embedding of the transponder 3 in the elastic silicone 6 causes a mechanical decoupling of the transponder 3 from external influences such as thermal expansion, deformation, etc. To mount the transponder 3 in the press tool 1, the transponder 3 is first inserted into the pot-shaped protective cap 4. The silicone 6 is then poured into the pot-shaped protective cap 4 and the protective cap 4 is closed by the plug 5 by pressing the plug 5 into the protective cap 4.

The transponder chamber 2 has an annular groove 7 at its bottom, which forms an overpressure absorption chamber. When the package including the transponder 3, the protective cap 4, and the plug 5 is pressed into the transponder chamber 2, excess pressure builds up in the transponder chamber 2, which in the worst case can lead to the transponder 3 subsequently becoming detached from the transponder chamber 2. The annular groove 7 therefore forms an overpressure absorption chamber, which ensures that the overpressure generated when pressing in the package including the transponder 3, the protective cap 4, and the plug 5 does not become too great.

The unintentional release of the transponder 3 from the transponder chamber 2 is also prevented by the fact that the protective cap 4 has several barbs 8 in its outer wall, which are arranged offset in the pressing-in direction. The uppermost barb 8 engages positively in the ring groove 7, thereby anchoring the protective cap 4 positively in the transponder chamber 2.

In addition, the protective cap 4 is glued into the transponder chamber 2.

The protective cap 4 is therefore anchored to the transponder 3 in the transponder chamber 2 by friction, force, and also material bonding. This anchoring by various types of connection (material-locking, friction-locking, force-locking) reliably prevents the protective cap 4 with the transponder 3 from coming loose from the transponder chamber 2 again during operation after installation.

Finally, the drawings show a step 9 in the inner wall of the protective cap 3. When the plug 5 is pressed into the protective cap 4, the step 9 forms a stop for the plug 5. This ensures that a defined receiving space for the transponder 3 is created when the plug 5 is pressed into the protective cap 4.

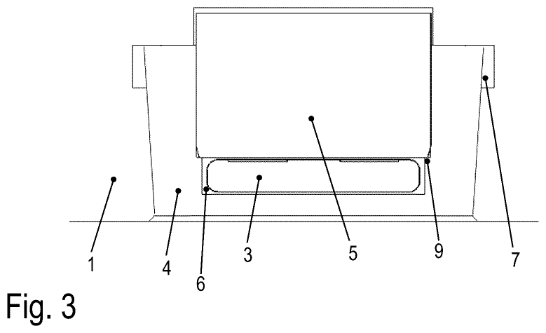

FIG. 3 shows a modified embodiment that largely corresponds to the embodiment described above and shown in FIGS. 1 and 2, so that reference is made to the above description to avoid repetition, with the same reference numerals being used for corresponding details.

A special feature of this embodiment is that the transponder chamber 2 widens conically toward its bottom. The package including the protective cap 4, the plug 5, and the transponder 3 can be inserted by heating the pressing tool 1 and cooling the protective cap 4, which causes the transponder chamber 2 to expand and the package including the protective cap 4, plug 5, and transponder 3, thereby enabling the package to be inserted into transponder chamber 2. The transponder chamber 2 on the one hand and the protective cap 4 on the other hand are therefore dimensioned in such a way that the protective cap 4 can only be inserted into the transponder chamber 2 and pulled out of the transponder chamber 2 when the protective cap 4 has cooled down or the pressing tool 1 has been heated.

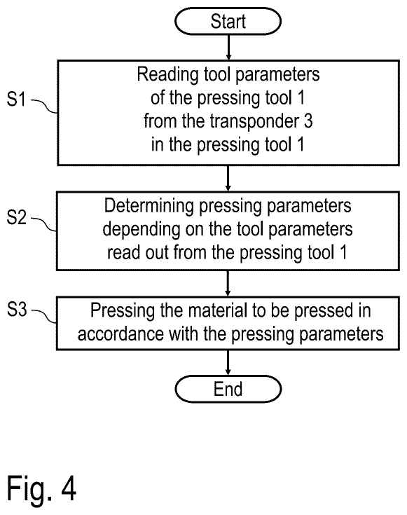

FIG. 4 shows a flow chart illustrating the operating method according to the disclosure.

In the first step S1, tool parameters (e.g. dimensions, thermal expansion coefficient of the material of the pressing tool 1) are first read out from the transponder 3.

In a further step S2, pressing parameters (e.g. pressing force-time characteristic curve) are then determined as a function of the tool parameters read out from the pressing tool 1.

In a next step S3, the pressed material is then pressed in accordance with the pressing parameters thus determined.

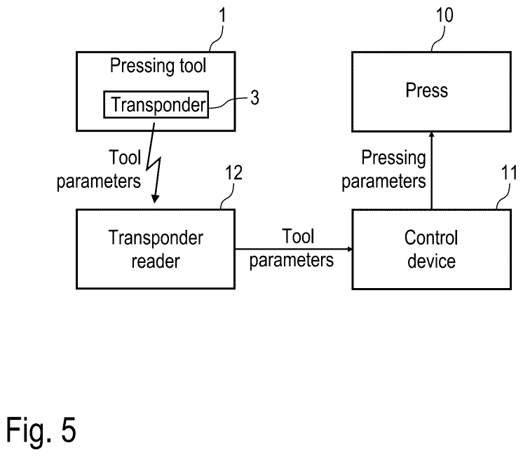

Finally, FIG. 5 shows a simplified schematic representation of a pressing device according to the disclosure.

The pressing device according to the disclosure initially has a press 10, which serves to press food products according to specified pressing parameters.

The pressing parameters are determined by a control device 11. For this purpose, a transponder reader 12 reads the tool parameters of the pressing tool 1 from the transponder 3 and reports them to the control device 11. The control device 11 then determines the pressing parameters depending on the tool parameters read out. In this way, the pressing parameters can be specifically adapted to the respective pressing tool 1.

The disclosure is not limited to the preferred embodiments described above. Rather, the disclosure also encompasses variants and modifications that likewise make use of the inventive concept and therefore fall within the scope of protection. In particular, the disclosure also claims protection for the subject matter and features of the dependent claims independently of the respective claims referred to. The disclosure therefore encompasses various aspects of the disclosure that enjoy protection independently of each other.

The disclosure offers various advantages, which can be summarized as follows:
The disclosure prevents the unwanted release of a transponder from a transponder chamber of a pressing tool, as occurs in the prior art.
When pressing food products, the pressing parameters can be adjusted specifically for each tool according to the respective pressing tool.
By using the tool parameters read from the transponder, the pressing chamber in the pressing device can be closed with a minimum gap.
The embedding of the transponder in the elastic material (e.g. silicone) enables mechanical decoupling from external influences such as thermal expansion, deformation, etc.
The disclosure enables hygienic installation of the transponder in the pressing tool.

### LIST OF REFERENCE SIGNS

1 Pressing tool
2 Transponder chamber in the pressing tool for holding the transponder
3 Transponder
4 Protective cap for the transponder
5 Plug
6 Silicone for embedding the transponder in the protective cap
7 Ring groove of the transponder chamber as an overpressure absorption chamber
8 Barbs in the outer surface of the protective cap
9 Step in the inner wall of the protective cap as a stop to limit the press-in movement of the plug
10 Press
11 Press control device
12 Transponder reader

1. A pressing tool for use in a pressing device for pressing material, the pressing tool comprising:
a transponder chamber, wherein a portion of the transponder chamber forms an overpressure absorption chamber; and
a transponder arranged in the transponder chamber,
wherein the transponder chamber is not completely filled when the transponder is installed, and
wherein the overpressure absorption chamber absorbs overpressure generated when the transponder is pressed into the transponder chamber.

2. The pressing tool according to claim 1, wherein the overpressure absorption chamber is a ring groove which surrounds the transponder chamber at a bottom of the transponder chamber.

3. The pressing tool according to claim 2, wherein a protective cap has at least one form-fitting element on its outer circumferential edge, which, when assembled, forms a form-fitting connection with a corresponding complementary form-fitting element in the transponder chamber, thereby anchoring the protective cap form-fittingly in the transponder chamber.

4. The pressing tool according to claim 3, wherein
the form-fitting element on the protective cap is a barb, and
a complementary positive locking element in the transponder chamber is the overpressure absorption chamber.

5. The pressing tool according to claim 1, wherein the transponder is arranged in a pot-shaped protective cap which is inserted into the transponder chamber of the pressing tool and covers the transponder with its bottom facing outwards.

6. The pressing tool according to claim 5, wherein the protective cap has at least one form-fitting element on its outer circumferential edge, which, when assembled, forms a form-fitting connection with a corresponding complementary form-fitting element in the transponder chamber, thereby anchoring the protective cap form-fittingly in the transponder chamber.

7. The pressing tool according to claim 6, wherein
the form-fitting element on the protective cap is a barb, and
a complementary positive locking element in the transponder chamber is the overpressure absorption chamber.

8. The pressing tool according to claim 5, wherein the transponder inserted into the protective cap is covered on an inside by a plug which is inserted into the pot-shaped protective cap.

9. The pressing tool according to claim 8, wherein
a stop is provided which limits a pressing-in movement of the plug when the plug is pressed into the protective cap,
the stop is arranged on an inner wall of the protective cap or on an outer wall of the plug or on a pressing-in aid.

10. The pressing tool according to claim 8, wherein the protective cap, the transponder, and the plug form a package that is pressed and/or glued into the transponder chamber in the pressing tool.

11. The pressing tool according to claim 5, wherein the transponder is embedded in a medium in the protective cap.

12. The pressing tool according to claim 5, wherein the transponder chamber and the protective cap are dimensioned such that the protective cap can only be inserted into the transponder chamber or pulled out of the transponder chamber when the protective cap has cooled down and shrunk thermally and/or the pressing tool has heated up and expanded thermally.

13. The pressing tool according to claim 1, wherein the transponder chamber in the pressing tool widens towards its bottom.

14. The pressing tool according to claim 1, wherein a volume of the overpressure absorption chamber is at least 3% of a total volume of the transponder chamber.

15. The pressing tool according to claim 14, wherein the transponder is an RFID transponder.

16. An operating method for a pressing device for pressing pressed material, comprising:
pressing the material to be pressed with a pressing tool in accordance with predetermined pressing parameters,
reading out at least one tool parameter of the pressing tool from a transponder in the pressing tool; and
adjusting the pressing parameters depending on the tool parameter read out.

17. The operating method according to claim 16, wherein the pressing parameters comprise at least one of the following:
end position of at least one travel axis during pressing and
press profile as a press force-time characteristic curve or press stroke-time characteristic curve.

18. The operating method according to claim 16, wherein the tool parameter read out from the transponder comprises at least one of the following tool parameters of the pressing tool:
dimensions of the pressing tool,
manufacturing tolerances of the dimensions of the pressing tool, and
thermal expansion coefficients of the pressing tool.

19. The operating method according to claim 16, further comprising:
receiving signals from the transponder, and
determining a correct or incorrect adjustment of the transponder in the press tool on based upon received signals.

20. A pressing device for pressing material comprising
a pressing tool with a transponder;
a transponder reader for reading the transponder; and
a control device for controlling a pressing process according to specific pressing parameters, and
wherein at least one tool parameter of the pressing tool is stored on the transponder, and the control device adjusts the pressing parameters depending on the tool parameter read out of the transponder by the transponder reader.
